(19) United States
(12) Patent Application Publication
(10) Pub. No.: US 2009/0138611 A1
(43) Pub. Date: May 28, 2009

(54) System And Method For Connection Of Hosts Behind NATs

(76) Inventors: Yu-Ben Miao, Tainan (TW); Yung-Li Chang, Tainan (TW); Hsiang-Kai Liao, Taichung (TW); Ce-Kuan Shieh, Tainan (TW)

Correspondence Address: LIN & ASSOCIATES INTELLECTUAL PROPERTY, INC., P.O. BOX 2339, SARATOGA, CA, 95070-0339, US

(21) Appl. No.: 12/119,507

(22) Filed: May 13, 2008

(30) Foreign Application Priority Data
Nov. 27, 2007 (TW) 096145011

(51) Int. Cl. G06F 15/173

(52) U.S. Cl. 709/228

(57) ABSTRACT

Disclosed is a system and method for connection of host behind network address translators. The system includes a server placed in a public network, and a transparent middleware (TMW). The server records the related data between each host and one or more NAT devices. The TMW may be performed in each host. When a first host of a first NAT device tries to establish connection to a second host of a second NAT device, through the server, the TMW looks up a first IP address mapping from the first host to the second NAT device, and a second IP address mapping from the second host to the first NAT device. Accordingly, the TMW accomplishes the support for establishing connection between the first and the second hosts.

### FIELD OF THE INVENTION

The present invention generally relates to a system and method for network address translation (NAT), and more specifically to a system and method for connection of hosts behind NATs.

### BACKGROUND OF THE INVENTION

With the growth of the Internet, problems reveal the shortage of IPv4's address space. As more and more computer hosts are connecting into the Internet, the speedy growth rate makes IPv4's 32-bit addresses space depletion. To mitigate the problem, Network Address Translator (NAT) is designed to reuse part of IPv4's addresses. These reusable addresses are called private IP addresses to distinguish from other globally unique public IP addresses. Multiple hosts behind NAT can use private IP addresses to form a private network and share with one or few public IP addresses via the address/port translating of NATs. In a NAT, an IP mapping table records the translating rule between the private IP addresses/port and public IP addresses/port. This table directs the NAT to translate the inbound and outbound traffic. In consequence, the same private IP addresses can be reused in different private networks and the problem of IPv4 address's shortage can be alleviated.

FIG. 1 shows an exemplary schematic view of a host behind NAT to communicate with external web server host through NAT. Referring to FIG. 1, a host 103 behind a NAT device 101 transmits an outbound packet through the NAT device 101 to the external web server host 105 on the Internet. NAT device 101 must translate the source IP address of the outbound packet from private IP address, such as 192.168.50.100, to public IP address, such as 140.116.175.55 before sending the outbound packet to the Internet. Then, NAP IP mapping table 110 of NAT device 101 records the IP address and the port numbers of the source IP address and destination IP address, such as [192.168.50.100:44244=>168.95.1.1:80].

When NAT device 101 receives an inbound packet from web server host 105 on the Internet, according to NAT IP mapping table 110, NAT device 101 translates the destination IP address of the packet, i.e., 140.116.177.55, to the corresponding private IP address, i.e., 192.168.50.100. If there is no corresponding private IP address in NAT IP mapping table 110, the inbound packet will be dropped by the NAT device 101.

Typically, NAT devices may be classified into two types. The first type is the cone-based NAT, and the second type is symmetric NAT. The difference between the two types is in the mapping rule of port number for the outbound packets. A public IP address/port in the cone-based NAT may map to a plurality of private IP addresses/ports, while the mapping rule of the symmetric NAT is limited to one-to-one mapping.

The cone-based NAT may be further classified into full-cone NAT, restricted-cone NAT and port restricted-cone NAT. The major difference among the three is the way of NAT device filtering inbound packets.

FIG. 2A shows a schematic view of an exemplary operation of a full-cone NAT. Host A is behind a NAT and connect with host C which is in the public network. Full-cone NAT device 201 first translates the private IP address/port [IPa, Pa] of the packet from host A to public IP address/port [IPna, Pa]. NAT device 201 then combines public IP address/port [IPna, Pa] with public IP address/port [IPc, Pc] of host C to form [IPna, Pa; IPc, Pc]. Therefore, host B and host D in the public network may send packet with public IP address/port [IPna, Pa], and the packet will forward to host A behind NAT device 201.

FIG. 2B shows a schematic view of an exemplary operation of a restricted-cone NAT. The operation of restricted-cone NAT device 211 is similar to that of full-cone NAT device 201. They are different solely in term of restrictions to particular source IP address. As shown in FIG. 2B, only host C on the public network may establish connection to host C behind NAT device 211; that is, even when host C changes port number from Pc to Pc₁. In fact, host B and host D in the public network cannot establish connection to host A. The restricted-cone NAT may provide the host behind NAT more privacy and protection.

FIG. 2C shows a schematic view of an exemplary operation of the port restricted-cone NAT. The port restricted-cone NAT has more restrictions on operation than previous NAT devices. As shown in FIG. 2C, if host C in the public network changes port number from Pc to Pc₁, the packet transmitted to host A behind Nat device 221 will be dropped by NAT device 221 because the change of the port number connected to port restricted-cone NAT device 221.

FIG. 2D shows a schematic view of an exemplary operation of the symmetric NAT. The difference between the operation of the symmetric NAT and that of the port restricted-cone NAT is the binding rule on the port number of the outbound packet. As shown in FIG. 2D, in symmetric NAT, each network connection has different binding rule of port number. For example, host A behind symmetric NAT device 231 may send a packet with public IP address/port [IPna, Pa] to host C in the public network and the public IP address/port [IPna, Pa] is combined with public IP address/port [IPc, Pc] of host C behind external NAT, correspondingly, host C may uses address IPc and port number Pc to send the packet to host A behind NAT device 231.

Although NAT allows the hosts to reuse the same IP addresses, there is negative impact. NAT device has to set up the translation rule before the connection establishment, only the host behind NAT may be the originating host and the host in the public network can be the terminating host. This means that it is impossible to define server behind the NAT device, and also impossible to establish connections between two hosts behind two different NATs. It violates the end-to-end connectivity model of the Internet. If the server or the host at both ends is behind NAT, the network application is not inherited because of the hindrance from NAT deployment.

To solve the above problem, a possible solution is to use relay approach or the hole punching approach for the external server. The relay approach is a typical NAT traversal method. This approach solves the problem by means of a relay server located in the public network. After each end host has established the connection with the relay server in the public network, all the packets will be forwarded by the server. In this manner, the detoured data path will consume extra network resource and the packet delivery suffers longer transmission time.

The hole punching approach is to let hosts behind NAT device to establish connection directly. Both end hosts send out a packet to register with NAT mapping table before establishing the connection. For example, the Simple Traversal of UDP through NATs and TCP (STUNT) is a well-known hole punching approach. Before the direct TCP connection, both ends of TCP connection must send out an SYN packet to other end simultaneously. This hole punching approach defines certain coordinate processes. Although this approach is an efficient method of NAT traversal, applications have to be modified or redesigned one by one to adapt to this coordinate process for integration.

### SUMMARY OF THE INVENTION

The disclosed exemplary embodiments of present invention may provide a system and method for connection of hosts behind NATs.

In an exemplary embodiment, the disclosed is directed to a system for connection of hosts behind NATs. The system comprises a server located in a public network for receiving the registration of each host and recording the related information of each host and at least a NAT device; and a transparent middleware (TMW) executed on each host respectively. When a first host of a first NAT device tries to establish connection to a second host of a second NAT device, through the server, the TMW looks up a first IP address mapping from the first host to the second NAT device, and a second IP address mapping from the second host to the first NAT device. Accordingly, the TMW accomplishes the support for establishing connection between the first and the second hosts.

In another exemplary embodiment, the disclosed is directed to a method for connection of hosts behind NATs. The method comprises a receiving host and a transmitting host registering through TMW to the server; the transmitting host requesting to the server for the private IP address information of the receiving host; the server replying the private IP address information of the receiving host to the transmitting host; the transmitting host requesting to the server for the IP address information of the receiving NAT device; the server replying the IP address information of the receiving NAT device to the transmitting host; and TMW transmitting the IP address information of the transmitting NAT device to the receiving host.

The aforementioned embodiments are applicable to the situation when hosts behind NATs try to establish connection. For example, the external host tries to establish the connection to a host behind NAT, or hosts behind different NATs try to establish connection with each other.

The foregoing and other features, aspects and advantages of the present invention will become better understood from a careful reading of a detailed description provided herein below with appropriate reference to the accompanying drawings.

### BRIEF DESCRIPTION OF THE DRAWINGS

FIG. 1 shows an exemplary schematic view of a host behind a NAT communicating through NAT with a server host outside of the NAT.

FIG. 2A shows a schematic view of an exemplary operation of a full-cone NAT.

FIG. 2B shows a schematic view of an exemplary operation of a restricted-cone NAT.

FIG. 2C shows a schematic view of an exemplary operation of a port restricted-cone NAT.

FIG. 2D shows a schematic view of an exemplary operation of a symmetric NAT.

FIG. 3 shows a schematic view of an exemplary NAT system, consistent with certain disclosed embodiments.

FIG. 4 shows a schematic view of an exemplary operation of NAT, consistent with certain disclosed embodiments.

FIG. 5 shows a schematic view of an exemplary TCP 3-way handshake protocol, consistent with certain disclosed embodiments.

FIG. 6 shows a schematic view of an exemplary registration process, consistent with certain disclosed embodiments.

FIG. 7 shows a schematic view of an exemplary operation of a host requesting a DNS IP lookup, consistent with certain disclosed embodiments.

FIG. 8 shows a schematic view of an exemplary operation of a NAT system applied in TCP mode, consistent with certain disclosed embodiments.

FIG. 9 shows a schematic view of an exemplary operation of a NAT system applied in UDP mode, consistent with certain disclosed embodiments.

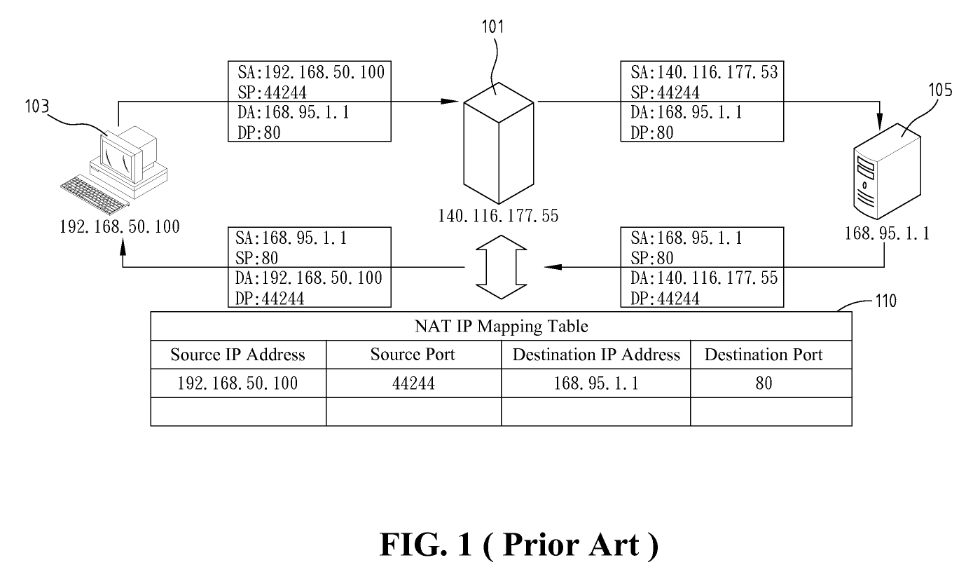

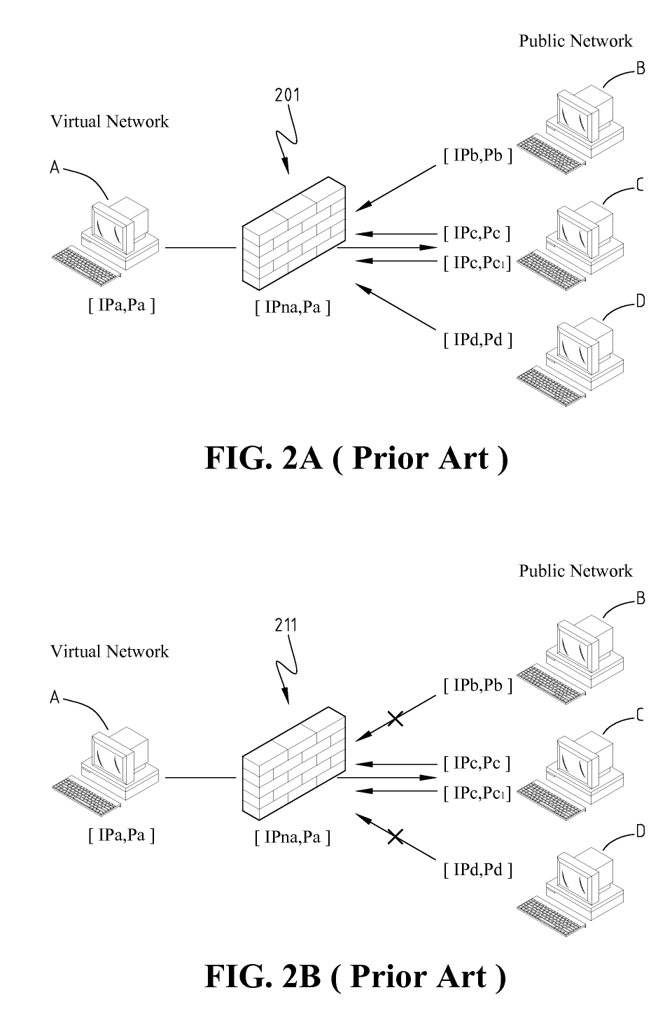

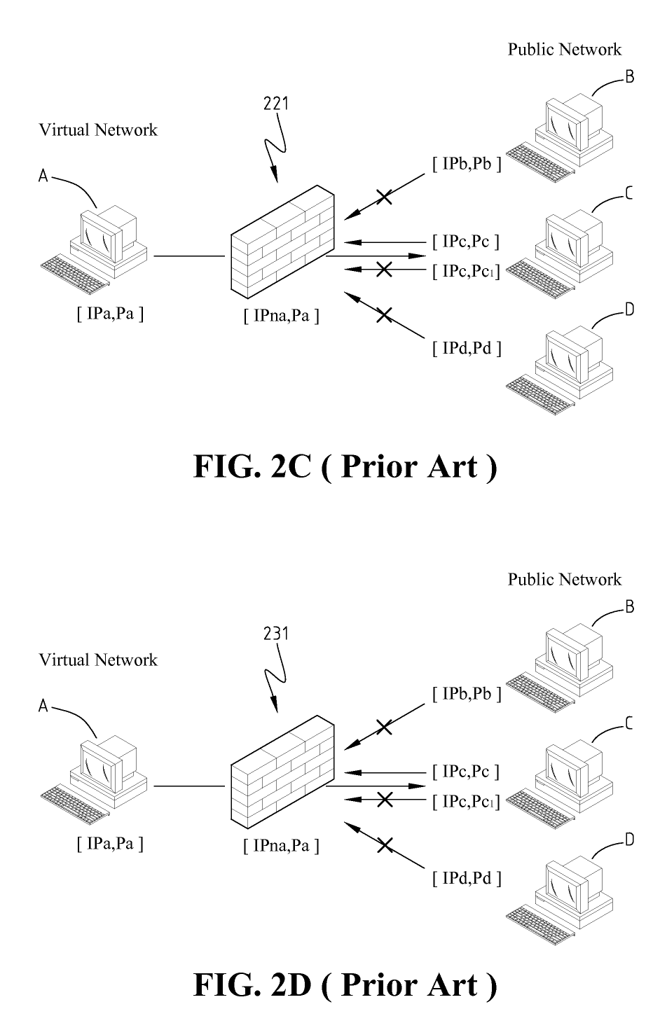

### DETAILED DESCRIPTION OF THE PREFERRED EMBODIMENTS

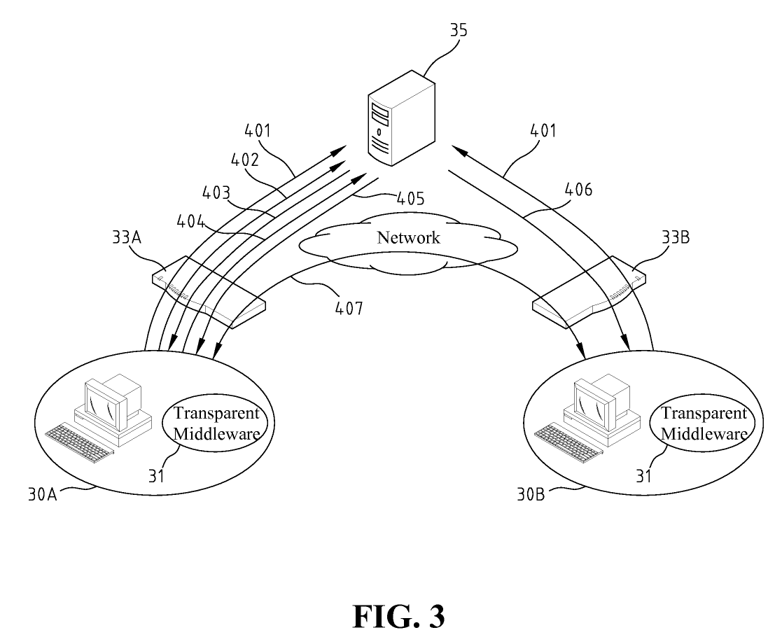

FIG. 3 shows a schematic view of an exemplary NAT system, consistent with certain disclosed embodiments. The NAT system is applicable to establishing connection between two hosts behind NAT device, such as, an external host trying to connect to a host behind a NAT device, or two hosts behind difference NAT devices trying to establish connection.

In FIG. 3, for example, first host 30A and second host 30B are behind first NAT device 33a and second NAT device 33b respectively. Hosts 30A and 30B try to establish connection.

Referring to FIG. 3, the NAT system comprises a server 35 and a transparent middle (TMW) 31. Server 35 is located in a public network for receiving the registration of first host 30A and second host 30B, and recording related information of each host and each NAT device. The related information may include domain names of first host 30A and second host 30B, the IP address/port mapping of first host 30A and first NAT device 33A, and the IP address/port mapping of second host 30B and second NAT device 33B. TMW 31 may be executed on first host 30A and second host 30B, respectively.

In the example of FIG. 3, when first host 30A and second host 30B try to establish connection to each other, first host 30A and second host 30B execute TMW 31 respectively. TMW 31 inquires through server 35 of the IP address mapping between first host 30A and second NAT device 33B, and the IP address mapping between second host 30B and first NAT device 33A, and accomplishes the support of establishing connection between first host 30A and second host 30B.

The system is applicable to a first NAT device different from a second NAT device, and the first host and the second host behind the first NAT device and the second NAT device, respectively. The system is also applicable to the case when the first NAT device and the second NAT device, and the first host and the second host are behind the same first NAT device.

TMW 31 may be installed at the kernel level or the user level of the host. When installed at the kernel level, TMW 31 is to rewrite packet driver. When installed at the user level, TMW 31 may use the driver socket routine.

First host 30a and second host 30B, for example, may be a notebook PC, desktop PC, a server or any combination of the above.

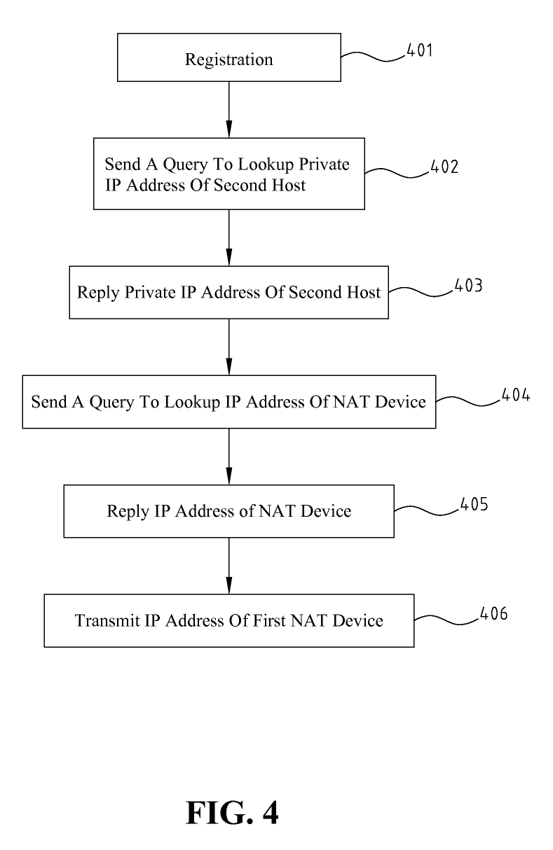

Labels 401-406 shown in FIG. 3 indicate the operation flow of NAT, which will be described in detailed in FIG. 4. The following description refers to FIGS. 3-4.

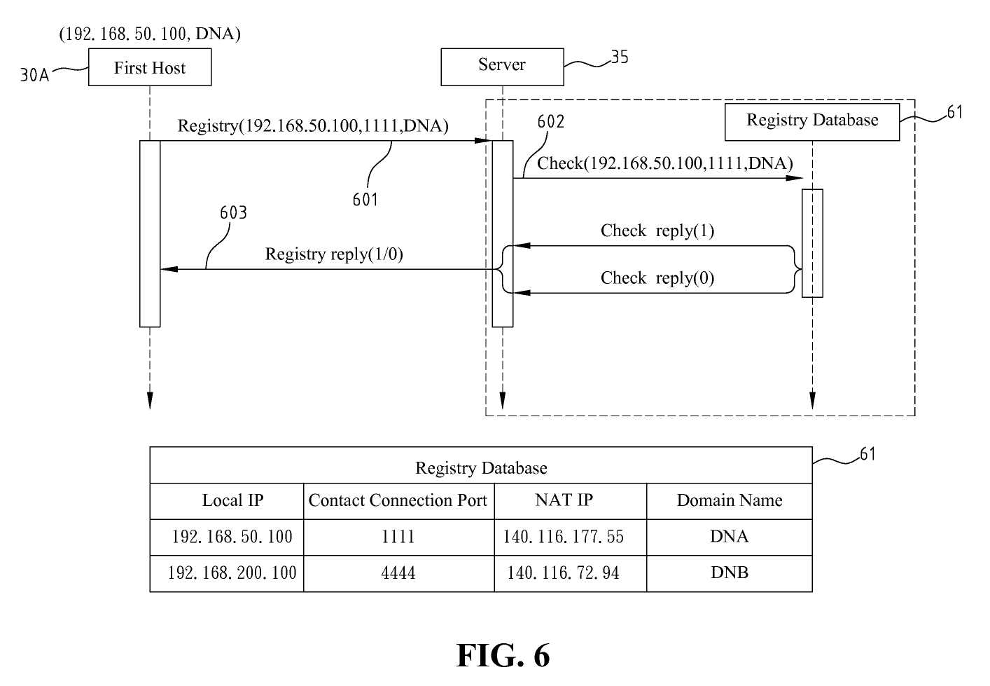

Step 401 is the registration activity. That is, first host 30A and second host 30B register to server 35. The registration activity makes server 35 check whether both first host 30A and second host 30B are online and makes server 35 check the uniqueness of the information of first host 30A and second host 30B in the public network where server 35 resides. The information may be such as IP address/port and domain name. Each host uses own IP address to register a domain name to any domain name system (DNS), and uses the domain name to register to server 35. The detailed registration process is described in FIG. 6.

Step 402 indicates sending a request to inquire of the private IP address of second host 30B. That is, first 30A may use the domain name of second host 30B to send a request to server 35 to inquire of the private IP address of second host 30B. For example, first host 30A may send a DNS request packet with the domain name of second host 30B to server 35.

Step 403 indicates replying the private IP address of second host 30B. That is, server 35 replies the private IP address information to first host 30A. For example, according to the domain name of second host 30B, server 35 may execute a DNS inquiry and find the private IP address/port of second host 30B.

Step 404 indicates sending a request to inquire of the IP address of the NAT device. That is, according to the private IP address information of second host 30B, TMW 31 on first host 30A send a request to inquire the IP address of the NAT device to server 35. For example, TMW 31 may send an IP lookup query packet with the information of the private IP address/port of second host 30B.

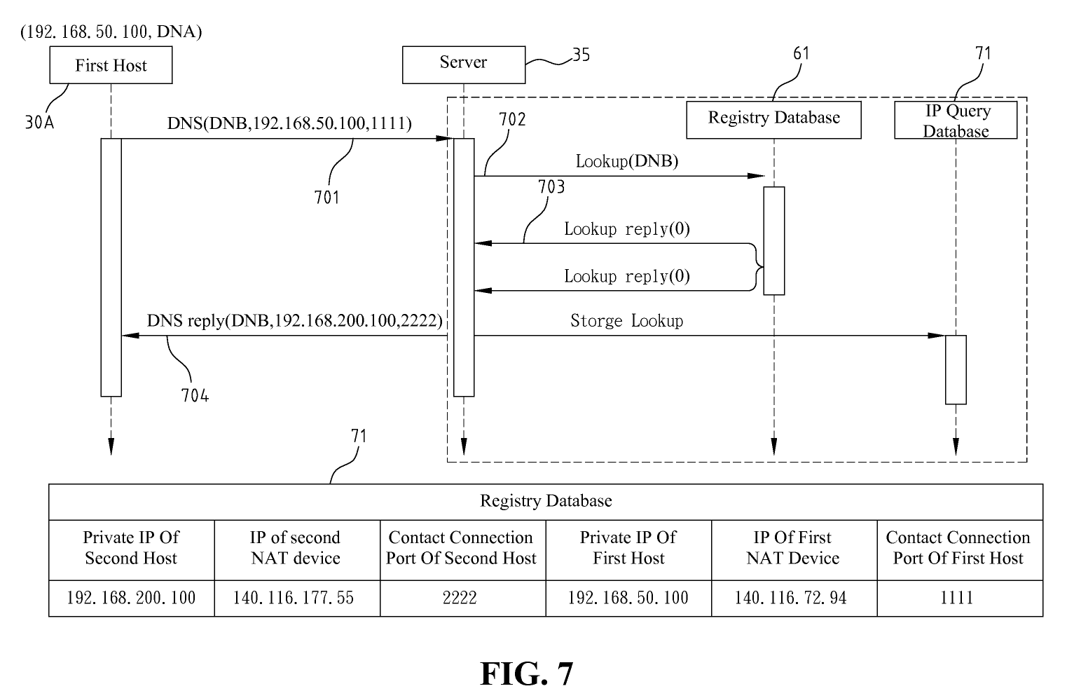

If in TCP mode, after first host 30A receives the DNS reply from server 35 (step 403), first host 30A will send a SYN packet with the IP address information of the second host to second host 30B. Therefore, the aforementioned IP lookup query packet may also include the information in SYN packet send by first host 30A, such as TCP packet serial number. The details of this process will be described in FIG. 7.

Step 405 indicates replying the IP address of second NAT device 33B. That is, server 35 replies the IP address of second NAT device 33B to first host 30A. For example, server 35 may reply an IP lookup reply packet to TMW 31 of first host 30A to inform of the IP address information of second NAT device 33B.

Step 406 indicates replying the IP address of first NAT device 33A. That is, server 35 replies the IP address of first NAT device 33A to second host 30B, and sends a connect request packet to second host 33B. The connect request packet may include the IP address/port information of first NAT 33A, as well as the information of the SYN packet sent by first host 30A.

The above steps 401-406 describe how the transparent traversal for NAT system supports the connection establishment between two hosts behind different NAT devices.

In other words, the connection support may include: receiving host and transmitting host both registering to the server through TMW; the transmitting host sending request for private IP address of receiving host to the server; the server replying the private IP address of receiving host; the transmitting host sending request for IP address of receiving NAT device to the server; the server replying the IP address of receiving NAT device to transmitting host; and TMW sending IP address of transmitting NAT device to receiving host.

After finishing steps 401-406, first host 30A behind first NAT device 33A and second host 30B behind second NAT device 33B successfully establish connection. Then, first host 30A and second host 30B may transmit data to each other directly.

Thereby, TMW 31 of first host 30A records the mapping between the private IP address/port of second host 30B and the IP address/port of second NAT device 33B. Similarly, TMW 31 of second host 30B records the mapping between the private IP address/port of first host 30A and the IP address/port of first NAT device 33A.

According to the disclosed embodiments, first host 30A and second host 30B may execute TMW 31 respectively. The existing architecture and application programs on first host 30A and second host 30B, such as client/server or peer-to-peer (P2P) architecture, may directly connect without rewriting.

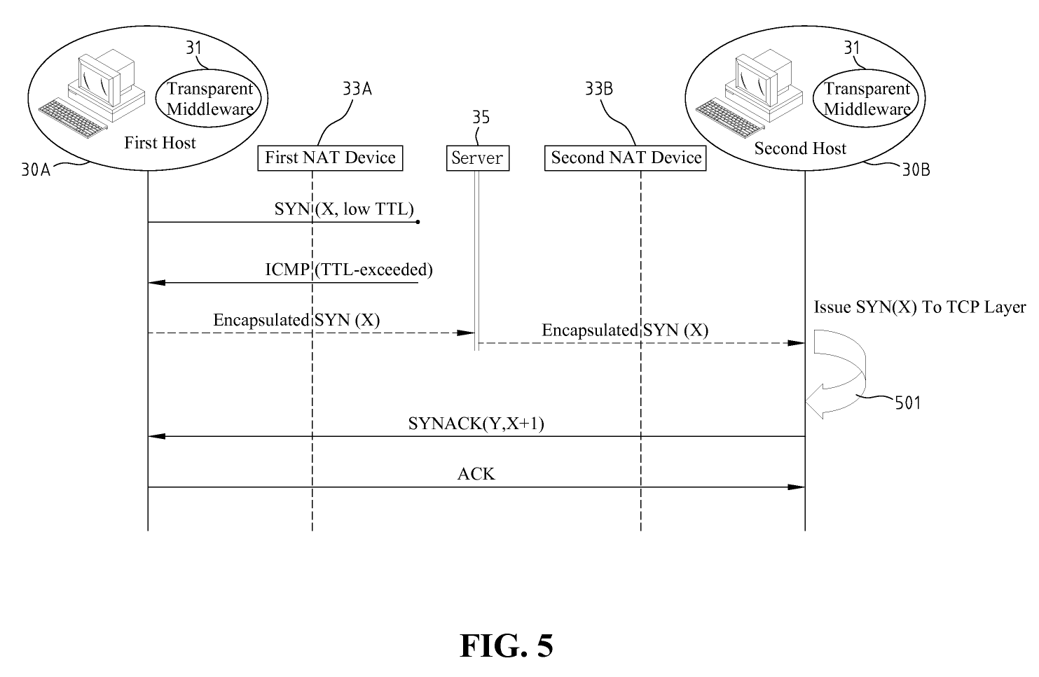

If the packets are transmitted in the TCP mode, first host 30A and second host 30B may accomplish the 3-way handshake protocol to establish the connection acknowledgement. FIG. 5 shows a schematic view of an exemplary TCP 3-way handshake protocol, consistent with certain disclosed embodiments.

Referring to FIG. 5, after first host 30A receives the IP address of second NAT device (step 405), first host 30A may send a low time to live (TTL) initialization SYN packet to second NAT device 33B. The SYN packet may be expressed as SYN(X, low TTL), where X is the sequence number of the TCP packet. Because the initialization SYN packet has a low TTL, first host 30A will receive an Internet control message protocol (ICMP) packet with exceeding TTL, expressed as ICMP (TTL-exceeded).

First host 30A then sends an encapsulated SYN packet (Encapsulated SYN(X)). Encapsulated SYN(X) includes the sequence number of initialization SYN packet, and is transmitted to second host 30B through server 35. When receiving this request packet, TMW 31 of second host 30B will generate an issue SYN packet with sequence number X (Issue SYN(X)) according to sequence number X of the initialization packet, and transmit Issue SYN(X) to the TCP layer of second host 30B, as indicated in label 501.

After receiving SYNACK(Y, X+1) packet, first host 30A replies an ACK packet to second host 30B. At this point, the TCP 3-way handshake protocol is accomplished.

According to the disclosed embodiments of the present invention, in step 501 of the TCP 3-way handshake protocol, TMW 31 of second host 30B generates Issue SYN(X) packet and transmits to TCP layer, the Issue SYN(X) packet does not need to go through the external network. In other words, the packet will not be filtered by the routers of the external ISP.

FIG. 6 shows a schematic view of an exemplary process for a host registration to the server, consistent with certain disclosed embodiments. The following description refers to both FIG. 3 and FIG. 6. The registration process includes three steps, indicated as labels 601-603.

Label 601 indicates sending registration related information of first host 30A to server 35. TMWS 31 of first host 30A first searches for the private IP address of first host 30A, such as 192.168.50.100, and the domain name, such as DNA. Then, TMW 31 randomly selects a contact port number CPort and generates a registration packet, such as Registry (192.168.50.100, DNA). The registration packet may include the private IP address, such as 192.168.50.100, of first host 30A, Cport, such as 1111, and domain name, such as DNA. TMW 31 transmits the registration packet to server 35.

Label 602 indicates server 35 checks the uniqueness of the related information of first host 30A. After server 35 receives the registration packet from first host 30A, server 35 checks with registry database 61 to determine whether the registration information (private IP address, Cport, and domain name) of first host 30A is unique, and obtains the registration result reply(1/0), where reply(1) indicates a successful registration, and reply(0) is a failure. The registry database may be stored in server 35.

Label 603 indicates server 35 replies the registration result to fist host 30A. If the registration is successful, server 35 replies a “registry reply(1)” packet, and stores the registration information of first host 30A in registry database 61, such as IP address, Cport, domain name and IP address of first NAT device.

If the registration is unsuccessful, server 35 replies a “registry reply(0)” packet, and TMW 31 randomly selects a new Cport again, and repeats the above steps 601-601 until the registration information of first host 30A is unique.

After both first host 30A and second host 30B register successfully, because NAT devices 33a, 33B have the capability of keeping packet alive so that during the period of packet alive, TMW 31 may still maintain connection to Cport for transmitting packets to server 35.

As aforementioned steps 402-403, according to domain name of second host 30B, first host 30A may send a request for inquiry of the private IP address of second host 30B to server 35. According to the domain name of second host 30B, server 35 may execute a DNS query to find the private IP address/port of second host 30B. Server 35 will record the relation between first host 30A and second host 30B. FIG. 7 further shows a schematic view of an exemplary operation of a host requesting a DNS IP lookup, consistent with certain disclosed embodiments.

Label 701 indicates that first host 30A sends a DNS request packet to server 35. The DNS request packet includes domain name DNB of second host 30B and private IP address of first host 30A added by TMW 31, such as 192.168.50.100, and port, such as 1111. The DNS request packet can be expressed as “DNS (DNB, 192.168.50.100.1111)”. TMW 31 of first host 31 sends the DNS request packet to server 35.

Label 702 indicates that server 35 sends a query packet of domain name DNB of second host 30B “Lookup(“DNB”)” to registry database 61.

Label 703 indicates if registry database 61 has no record of domain name DNB of second host 30B, registry database 61 replies a “Lookup reply(0)” packet to server 35. Server 35 sends another packet with domain name of second host 30B to another DNS for lookup.

Label 704 indicates if registry database 61 includes a record of domain name DNB of second host 30B, server 35 generates a new DNS response packet with private IP address/Cport of second host 30b, such as “DNS reply(192.168.50.100, 2222)”, and transmits to first host 30A. The related information of first host 30A and second host 30B, such as private IP address/Cport of first host 30A, IP address of first NAT device 33A, private IP address/Cport of second host 30B, and IP address of second NAT device 33B, will be recorded in IP lookup database 71. The packet format may be expressed as “Storage Lookup(192.168.200.100, 140.116.177.55, 2222, 192.168.50.100, 140.116.72.94, 1111)”.

Data transmission may be divided into two modes, i.e., in TCP mode and in UDP mode. The following describes exemplary operations in TCP mode and in UDP mode respectively for the disclosed NAT system with transparent traversal.

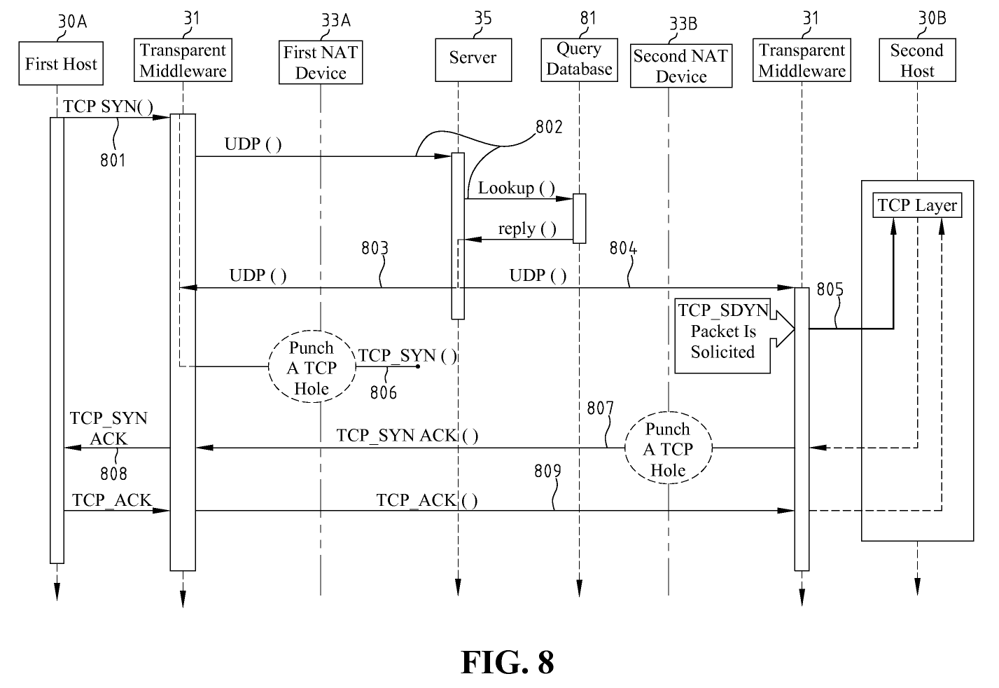

FIG. 8 shows a schematic view of an exemplary operation of a NAT system applied in TCP mode, consistent with certain disclosed embodiments. Referring to FIG. 8, in TCP data transmission mode, first host 30A behind first NAT device 33A and second host 30B behind second NAT device 33B execute TMW 31 respectively.

First host 30A and second host 30B first register to server 35, and first host 30A sends a DNS query packet to server 35 to obtain the private IP address of second host 30B.

When first host 30A and second host 30B try to establish a TCP connection, first host 30A sends a TCP_SYN packet with private IP address/port of second host 30B to second host 30B, as indicated by label 801. TMW 31 keeps the TCP_SYN packet and generates a new UDP packet to server 35. Server 35 sends a “Lookup( ) packet and uses the private IP address of second host 30B to inquire lookup database 81 for the IP address of second NAT device 33B, as indicated by label 802. The UDP packet includes the Cport, IP address, port and TCP sequence number of first host 30A and second host 30B.

According to the private IP address of second host 30B, server 35 inquires lookup database 81 of the IP address of second NAT device 33B, and replies to TMW 31 of first host 30A, as indicated by label 803.

Server 35 generates a new connection request packet and transmits to TMW 31, as indicated by label 804. The connection request packet includes the IP address of second host 30B, Cport and IP address/port of first host 30A, IP address of first NAT device 33A, and TCP packet sequence number. After TMW 31 receives connection request packet from server 35, a TCP_SYN packet is solicited to the TCP layer of second host 30B, as indicated by label 805.

On the other hand, after receiving the IP address of second NAT device 33B replied from server 35 (step 803), TMW 31 of first host 30A releases the original TCP_SYN packet, changes the private IP address of second host 30B in the TCP_SYN packet to IP address of second NAT 33B, and sends a low TTL TCP_SYN packet “TCP_SYN(X, low TTL)”. In this manner, the IP mapping table of first NAT device 33A records the IP address mapping from first host 30A to second NAT device 33B. In other words, a TCP hole is punched on first NAT device 33A, as indicated by label 806.

After the TCP layer of second host 30B receives the TCP_SYN packet (step 805), the AP layer of second host 30B will send a TCP_SUNACK packet to first host 30A, as indicated by label 807. To transmit TCP_SYNACK packet correctly, TMW 31 of second host 30B changes the private IP address of first host 30A in the TCP_SYNACK packet to the IP address of first NAT device 33A, and transmits to first NAT device 33A. Similarly, the IP mapping table of second Nat device 33B also records the IP address mapping from second host 30B to first Nat device 33A; i.e., punching a TCP hole on second NAT device 33B.

After TMW 31 of first host 30A receives a TCP_SYNACK packet, TMW 31 changes the IP address of second NAT device 33B in the TCP_SYNACK packet to the private IP address of second host 30B, and transits to the TCP layer of first host 30A, as indicated by label 808.

When the application programs of the AP layer of first host 30A receives the TCP_SYNACK packet from second host 30B, first host 30A sends a TCP_ACK packet to second host 30B to accomplish the TCP 3-way handshake protocol and establish TCP connection and acknowledgement, as indicated by label 809. Therefore, when the network packets are transmitted in TCP mode, the transmitting host and the receiving host may accomplish the TCP 3-way handshake to establish the connection acknowledgement.

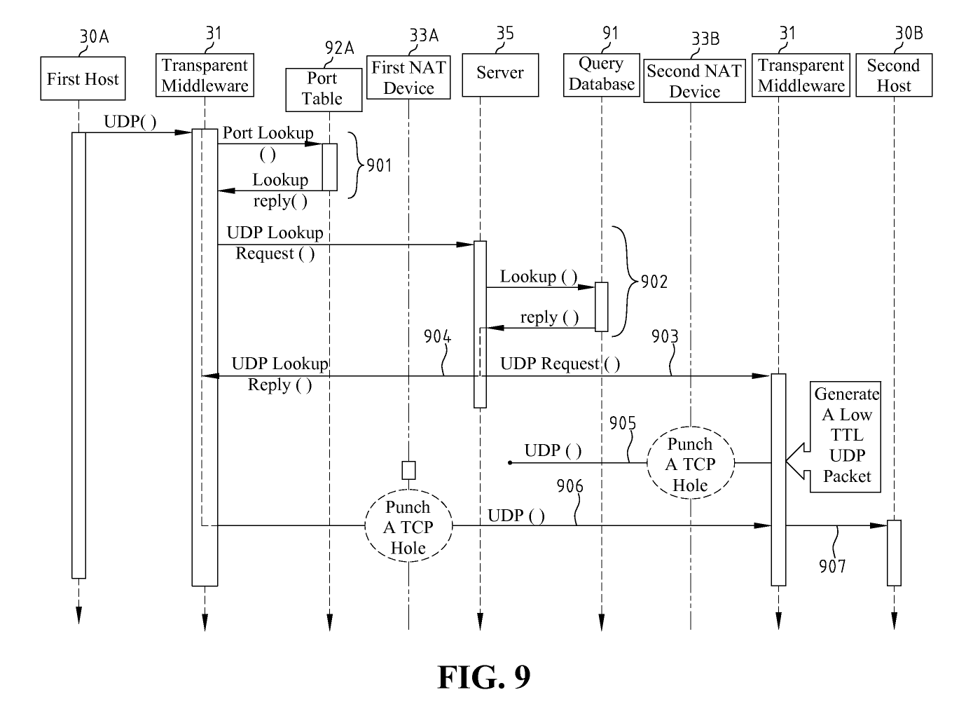

FIG. 9 shows a schematic view of an exemplary operation of a NAT system applied in UDP mode, consistent with certain disclosed embodiments. Referring to FIG. 9, in UDP data transmission mode, first host 30A and second host 30B register to server 35, respectively, and first host 30A uses the domain name 30B of second host 30B to inquire server to obtain the private IP address of second host 30B.

First host 30A first sends a UDP packet with private IP address of second host 30B. TMW 31 will look up the internal port table 92A, i.e., issuing “Port Lookup( )” to compare the private IP address/port of second host 30B and port table 92A and replies the result to TMW 31, i.e., returning “Lookup reply( )” to TMW 31, as indicated by label 901.

If port table 92A has no record of the private IP address/port of second host 30B, TMW 31 will generate a “UDP Lookup request( )” packet and transmit to server 35 for inquiring lookup database 91 of the IP address of second NAT device 33B; i.e., sending a “Lookup( )” packet and replying the result “reply( )” to server 35, as indicated by label. The UDP Lookup request( ) packet includes the IP address/port of first host 30A and second host 30B, and the Cport of first host 30A.

In the step indicated by 902, if the related information of second host 30B is correctly queried, server 35 will execute the following two tasks. The first is to generate a “UDP Request( )” to ask second host 30B to generate a UDP packet with the IP address of first NAT device 33A as the destination address, as indicated by label 903. The UDP Request( ) packet includes the IP address/port and Cport of first host 30A, the IP address of first NAT device 33A, and the port of second host 30B.

The other task is for server 35 to reply the IP address of second NAT device 33B to first host 30A; i.e., replying the “UDP Lookup reply( )” to server 35, as indicated by label 904.

After receiving the UDP Request ( ) packet, TMW 31 of second host 30B sends a low TTL UDP packet. Thereby, the IP mapping table of second NAT device 33B records the IP address mapping from second host 30B to first NAT device 33A. In other words, a UDP hole is punched on second NAT device 33B, as indicated by label 905.

In the step indicated by 904, after receiving the UDP Lookup reply( ) packet replied from server 35, TMW 31 of first host 30A releases the original UDP packet, changes the destination address in the UDP packet from the private IP address of second host 30B to IP address of second NAT 33B, and transmits to second host 30B. Thereby, the IP mapping table of first NAT device 33A records the IP address mapping from first host 30A to second NAT device 33B. In other words, a UDP hole is punched on first NAT device 33A, as indicated by label 906.

After TMW 31 of first host 30A receives a UDP packet from first host 30A, because the IP mapping table of second NAT device 33B has recorded the IP address mapping from second host 30B to first NAT device 33A, TMW 31 changes the source address in the UDP packet from IP address of first NAT device 33A to the private IP address of first host 30A, and transmits to the TCP layer of second host 30B, as indicated by label 907. The application layer of second host 30B may then expect to receive the UDP packets from first host 30A.

In the step indicated by 901, if port table 92A already recorded the IP address of second NAT device 33B, then the step indicated by 907 is executed directly.

FIG. 8 and FIG. 9 shows the disclosed embodiments may be applicable to TCP mode and UDP mode respectively, and describe how the two hosts behind two different NAT devices able to connect and communicate directly without rewriting the applications on the NAT device and host.

In the disclosed embodiments of the present invention, either first NAT device 33A or second NAT device 33B may be a stand-alone server or a server cluster, or even a module operating in a host. In other words, the first Nat device and the second NAT device may be a NAT unit with many possible implementations, such as a single server, a server cluster or a module on a host.

Although the present invention has been described with reference to the exemplary disclosed embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A network address translation (NAT) system, comprising:
a server, said server installed in a public network, receiving registration of each of a plurality of hosts and recording related information of each of said plurality of hosts and at least a NAT device; and
a transparent middleware (TMW) that is executed on each said host respectively;
when a first host behind a first NAT device trying to establishing connection with a second host behind a second NAT device, said TMW querying through said server to lookup IP address mapping from said first host to said second NAT device, and IP address mapping from said second host to said first NAT device; and accomplishing supporting said connection establishment between said first host and said second host.

2. The system as claimed in claim 1, wherein said server records domain name of each of said plurality of hosts, and IP address mapping from each of said plurality of hosts to a corresponding NAT device.

3. The system as claimed in claim 1, wherein said first NAT device is the same as said second NAT device, and said first host and said second host are hosts outside and behind said first NAT device, respectively.

4. The system as claimed in claim 1, wherein said first NAT device is different from said second NAT device, and said first host and said second host are hosts behind said first NAT device and said second NAT device, respectively.

5. The system as claimed in claim 1, wherein each of said plurality of hosts is a notebook computer, personal computer, server, or any combination of the above.

6. The system as claimed in claim 1, wherein said TMW is installed at the kernel level or the user level on each of said plurality of hosts.

7. The system as claimed in claim 1, wherein said server further includes a registry database for storing registry information of each of said plurality of hosts and related information with said at least a NAT device.

8. The system as claimed in claim 1, said system is applicable to data communication in transmission control protocol mode or user datagram protocol mode.

9. The system as claimed in claim 1, wherein said TMW on said first host and said second host respectively records IP address mapping from said first host to said second NAT device, and IP address mapping from said second host to said first NAT device.

10. The system as claimed in claim 1, wherein said first NAT device and said second NAT device are transparent NAT devices.

11. The system as claimed in claim 1, wherein said first NAT device and said second NAT device are NAT units, and each of said NAT units is implemented with a single server, a server cluster, or a module on a host.

12. A method for connecting hosts behind NAT devices, comprising:
a transmitting host and a receiving host registering through a transparent middleware (TMW) to a registry server;
said transmitting host sending a request to said server for private address information of said receiving host;
said server replying said private address information of said receiving host to said transmitting host;
said transmitting host requesting to said server for public address information of NAT device of said receiving host;
said server replying said public address information of said receiving NAT device to said transmitting host;
said server replying IP address information of said receiving NAT device to said transmitting host; and
said TMW transmitting IP address information of NAT device of said transmitting host to said receiving host.

13. The method as claimed in claim 12, said method is applicable to data transmission in transmission control protocol (TCP) mode or user datagram protocol (UDP) mode.

14. The method as claimed in claim 13, wherein in said TCP data transmission mode, said transmitting host and said receiving host accomplish a 3-way handshake protocol for establishing connection acknowledgement.

15. The method as claimed in claim 12, wherein said transmitting host requests to said server for IP address lookup of said receiving host through a domain name of said receiving host.

16. The method as claimed in claim 14, wherein said 3-way handshake protocol further includes:
said transmitting host transmitting a sequence number and a low time to live (TTL) synchronization (SYN) packet to said receiving NAT device;
said transmitting host sending a request packet with said sequence number through said server to said receiving host;
according to said sequence number, said receiving host generating another SYN packet with said sequence number and transmitting through said TMW to TCP layer of said receiving host;
application layer of said receiving host transmitting a synchronization acknowledge (SYNACK) packet to said transmitting host; and
said transmitting host replying an acknowledge (ACK) packet to said receiving host.

17. The method as claimed in claim 13, wherein said step of said host registering to said registry server further includes:
transmitting registration related information of said host to said server;
said server checking the uniqueness of said registration related information of said host; and
said server replying result of registration success or registration failure to said host.

18. The method as claimed in claim 17, wherein said registration related information of said host at least includes corresponding private IP address, contact connection port and domain name of said host.

19. The method as claimed in claim 17, wherein said server checks the uniqueness of said registration related information of said host through a registry database.

20. The method as claimed in claim 17, wherein when said result is registration failure for said host, said host randomly selects another contact connection port and repeats said registry step until said server confirms the uniqueness of said registration related information of said host.

21. The method as claimed in claim 12, wherein said step of said transmitting host requesting for said IP address information of said receiving NAT device further includes:
said transmitting host transmitting a packet with domain name of said receiving host to said server;
said server sending a query packet with said domain name of said receiving host to a registry database;
if said registry database having no record of said domain name of said receiving host, said server sending a packet with said domain name of said receiving host to another domain name system (DNS) for lookup; and
if said registry database having record of said domain name of said receiving host, said server replying said receiving host information to said transmitting host, and recording related information of said transmitting host and receiving host in an IP query database.

22. The method as claimed in claim 21, wherein said receiving host information replied by said server at least includes private IP address and port of said receiving host.

23. The method as claimed in claim 21, wherein said related information of said transmitting host and receiving host recorded in said IP query database at least includes private IP address/contact connection port of said transmitting host, IP address of said transmitting NAT device, private IP address/contact connection port of said receiving host, and IP address of said receiving NAT device.

24. The method as claimed in claim 21, said method is a transparent network address translation method.

25. The method as claimed in claim 12, wherein said private address is an IP address.

26. The method as claimed in claim 12, wherein said receiving NAT device and said transmitting NAT device are NAT units, and each of said NAT units is a single server, a server cluster or a module on a host.
